(19) United States
(12) Patent Application Publication
(10) Pub. No.: US 2026/0084152 A1
(43) Pub. Date: Mar. 26, 2026

(54) Array for a Microfluidic Device, Microfluidic Device, and Method for the Operation Thereof

(71) Applicant: Robert Bosch GmbH, Stuttgart (DE)

(72) Inventors: Anja Lippert, Leonberg (DE); Aaron Doerr, Leonberg (DE); Julian Kassel, Pforzheim (DE); Ronny Leonhardt, Gerlingen (DE)

(21) Appl. No.: 19/108,156

(22) PCT Filed: Sep. 6, 2023
(86) PCT No.: PCT/EP2023/074355

§ 371 Date: Mar. 1, 2025

(30) Foreign Application Priority Data
Sep. 9, 2022 (DE) 10 2022 209 420.4

(51) Int. Cl. B01L 3/00

(52) U.S. Cl. CPC B01L 3/502746; B01L 2200/0684; B01L 2300/0819; B01L 2300/0864; B01L 2300/0877; B01L 2400/086; B01L 2400/088

(57) ABSTRACT

An array for a microfluidic device is disclosed which has depressions that are formed in parallel rows in one side of an array. The side has, in adjacent rows, in each case at least one different surface property. The microfluidic device has at least one array chamber in which the array is arranged such that the rows extend parallel to a flow direction of a fluid. To operate the microfluidic device, a fluid is guided through the array chamber such that it flows along the rows over the side of the array.

The present invention relates to an array for a microfluidic device. Further, the present invention relates to a microfluidic device comprising the array. The invention also relates to a method for operating a microfluidic device.

### PRIOR ART

Microfluidic analysis systems, which can also be referred to as lab-on-chip systems, enable automated processing of chemical or biological samples for medical diagnostics. To perform multiple analyses with a single sample, they often have an array comprising a plurality of blind hole-shaped depressions with dried reagents pre-stored. The array is flushed with a reaction liquid and the depressions, also referred to as wells, are filled in this manner. The depressions can then be isolated from each other by means of a sealing liquid. This is described, for example, in DE 10 2018 204 624 A1.

After the sealing liquid has been introduced, chemical reactions take place in the depressions between the reaction liquid and the pre-stored reagents. The chamber in which the array is arranged is visually accessible. The results of the reactions can thus be evaluated by means of an optical sensor.

### DISCLOSURE OF THE INVENTION

The array for a microfluidic device consists in particular of silicon, which forms its base body. It has one side with a plurality of depressions that extend into the base body of the array and in which reagents in particular are arranged. The depressions are arranged in parallel rows. The side with the depressions is intended to be flushed with a reaction liquid in the microfluidic device. It is therefore arranged as the top side in the microfluidic device.

The filling of the depressions must occur in a reproducible and controlled manner. It is particularly important that no so-called crosstalk occurs between the individual depressions. Crosstalk refers to the phenomenon in which depressions that have already been filled are flushed out again by crossflows and the reagents pre-stored therein are distributed over the entire array. Flushing out and distributing the reagents may lead to undesirable chemical reactions that falsify or render the optical measurements unusable.

Only by preventing crosstalk can it be ensured that chemical reactions take place in the depressions reproducibly and with sufficient yield. The decisive factor for filling the depressions is the defined progression of the interface between air and a reaction mixture on the array, or two different fluids flowing in one after the other. This progression is significantly influenced by geometric dimensional deviations and local surface properties of the array, by the contours of the depressions, and by properties of the flow of the array. These can lead to unforeseen fluctuations in the movement of the boundary surface and thus trigger transverse movements. In addition, for example, increased wetting along the central axis of the array and/or increased lateral wetting may occur, which poses the risk of air pockets in adjacent corners of an array chamber in which the array is arranged, as well as incomplete wetting of the array.

It is provided, that the side of the array which has the depressions has at least one different surface property in adjacent rows. This achieves a uniform fluid flow across the array and favors the formation of a planar contact line by breaking and directing the contact line in a locally defined manner. As a result, crosstalk between individual depressions may be minimized during overflow, which improves the output quality of the optical analysis or even makes it possible in the first place if crosstalk means that measurements cannot be carried out. Preferably, but not necessarily, all adjacent rows may have different surface properties.

Preferably, the rows with different surface properties also continue in areas of the side of the array in which the depressions are formed, in which there are no depressions. This reduces the influence of adjacent walls of an array chamber on an analysis area of the array.

Preferably, the rows alternately belong to a first group and to a second group. In the rows of the first group, the side of the array in which the depressions are formed has at least a first surface property. In the rows of the second group, this side has at least one second surface property, which is different from the first surface property. Such a uniform pattern of alternating rows having two different surface properties, or two different groups of surface properties results in a particularly pronounced uniformity of flow.

A surface property is preferably a surface roughness. The surface roughness, also referred to as finish roughness, may be determined by various test methods, such as the confocal technique, conoscopic holography, white light interferometry or focus variation. The method for determining the surface roughness may be freely selected, wherein a different surface roughness should result in adjacent rows independent of the method selected. A change in the surface roughness is possible by etching the side of the array, for example. The surface roughness affects the hydrophilicity or hydrophobicity of the array and thus the flow behavior of a fluid on its surface. This effect is particularly pronounced when the fluid is an aqueous solution, as is generally used as a reaction liquid in microfluidic devices.

Particularly preferably, the surface roughness differs between two adjacent rows by a factor that lies in the range of 5 to 50. A lower factor causes only a low uniformity of flow. A higher factor can trigger tunnel effects.

Furthermore, it is preferred that a surface property is surface profiling. Such surface profiling, which can also be understood as a microstructuring of the surface roughness or directional roughness, can also be used for homogenization of a fluid interface or an inflow profile.

Particularly preferably, the surface profiling is in the form of grooves. Adjacent rows may differ in depth and/or distance and/or orientation of the grooves.

In one embodiment, the surface profiling has grooves in one row that run orthogonally to the row and other grooves in a row adjacent to that row that run along that row. The transverse grooves increase pinning effects within their row, while the longitudinal grooves reduce pinning effects.

The grooves may in particular have a rectangular, triangular or semi-circular cross section. Their depth is in particular in the range of 10 μm to 30 μm. A distance between two adjacent grooves in a row is preferably in the range of 20 μm to 100 μm. The determination of the surface profiling should be defined in particular taking into account the operating points (flow profile) and the fluid properties (contact angle).

In addition, it is preferred that a surface property is a surface height. As a result, channels are formed in the array that give a fluid flowing over the array a preferred direction and thus reduce crosstalk.

The surface height differs between two adjacent rows, preferably by a value in the range of 50 μm to 100 μm. On the one hand, this height difference is sufficient to cause a significant reduction of crosstalk and, on the other hand, it is not so large that it could lead to tunneling and the advance of fluid.

The width of the rows is determined by the diameter of the depressions, which is in particular in the range of 250 μm to 350 μm. The width is therefore in the range of 400 μm to 500 μm in particular.

The different surface properties, in particular different surface heights, different surface profiling and/or different surface roughnesses may also be advantageously combined for some or more rows. According to particular configurations, some rows may have one or more of these different surface properties.

The microfluidic device comprises at least one array chamber in which the array described above is arranged. The rows are parallel to a flow direction of a fluid.

If a surface property of the array is a surface height, then it is preferred that the surface height differs between two adjacent rows by a value that is in the range of 10% to 20% of a channel height of the array chamber. The channel height is understood to mean a distance from a highest point of the array to a top side of the array chamber. This height difference is advantageous for significantly reducing crosstalk without triggering tunnel effects.

The array chamber may in particular be an analysis chamber that comprises a transparent window above the side of the array, through which the contents of the depressions can be analyzed by means of optical methods.

In particular, the microfluidic device may be a cartridge provided to be inserted into a microfluidic analysis system. In such a cartridge, reagents are pre-stored and a sample liquid is introduced into the cartridge. After performing chemical reactions and an analysis of the reaction result, the cartridge may be discarded as a disposable article, while other components of the analysis system, such as an optical sensor, that is not a component of the cartridge, are reused.

In particular, the microfluidic device is configured to perform an amplification reaction, for example a PCR reaction or a rITA reaction. Set-up is performed by pre-storing the reagents needed for the amplification reaction.

In the method for operating the microfluidic device, a fluid is guided through the array chamber such that it flows along the rows over the sides of the array.

### BRIEF DESCRIPTION OF THE DRAWINGS

Exemplary embodiments of the invention are illustrated in the drawings and explained in more detail in the following description.

FIG. 1a shows a sectioned side view of an array chamber of a microfluidic device according to the prior art.

FIG. 1b shows a view of the array chamber according to FIG. 1a.

FIG. 2 shows a view of an array chamber of a microfluidic device according to an exemplary embodiment of the invention.

FIG. 3 shows a cross-sectional view of an array chamber of a microfluidic device according to an exemplary embodiment of the invention.

FIG. 4 shows a view of an array chamber of a microfluidic device according to another exemplary embodiment of the invention.

FIG. 5 shows a cross-sectional view of an array chamber of a microfluidic device according to another exemplary embodiment of the invention.

### EXEMPLARY EMBODIMENTS OF THE INVENTION

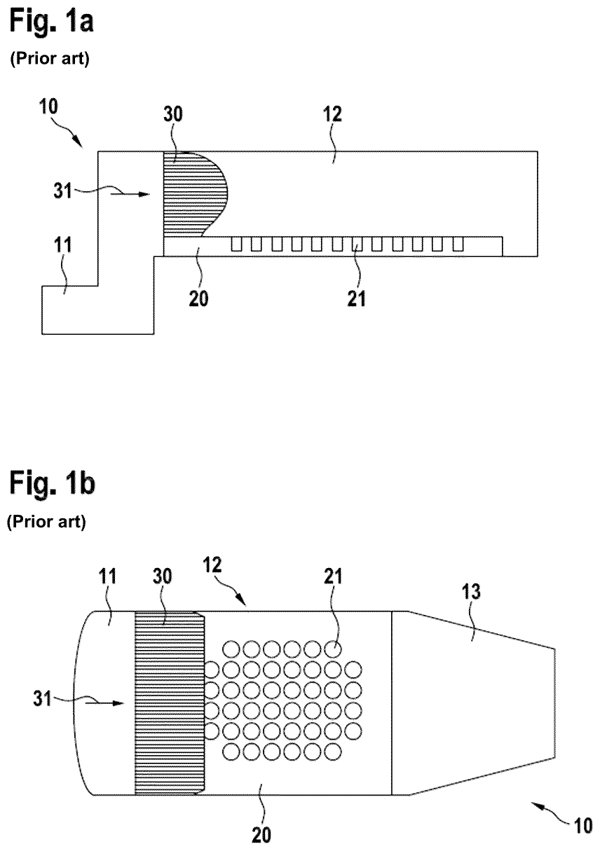

FIGS. 1a and 1b show a section of a microfluidic device 10 according to the prior art, e.g. as a disposable cartridge for an analysis system. An inlet channel 11 runs in a fluidic layer of the microfluidic device 10. It is redirected in steps into a higher lying array chamber 12. This opens into an outlet channel 13 opposite opening of the inlet channel 11. An array 20 is arranged in the array chamber 12, which is made of silicon, for example. It has forty-four depressions 21 on its top side. A fluid 30, which is an aqueous reaction liquid containing a biological sample, flows along a flow direction 31 through the inlet channel 11 into the array chamber 12 and flushes the array 20. A portion of the fluid 30 fills the depressions 21. The remaining fluid 30 is discharged from the array chamber 12 through the outlet channel 13.

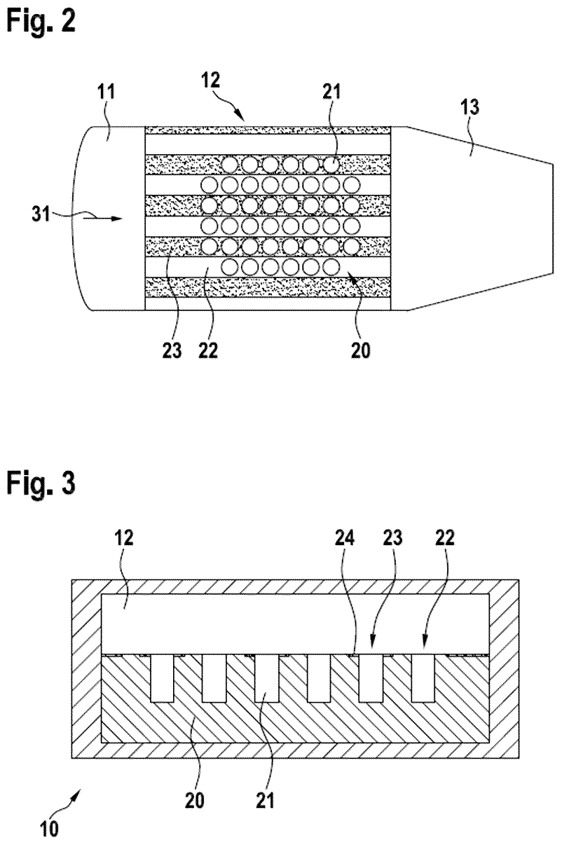

In FIG. 2, an array chamber 12 of a microfluidic device 10 according to a plurality of exemplary embodiments of the invention is shown. In contrast to the array chamber 12 of the microfluidic device according to the prior art, an array 20 is arranged in this array chamber 12, which has alternating rows 22, 23 with different surface properties. The rows 22, 23 run parallel to the flow direction 31. A width of the rows 22, 23 is selected such that a row of depressions 21 is arranged in each of these rows 22, 23. For example, the width is 450 μm. The alternating rows 22, 23 also continue in areas of the surface of the array 20 where there are no depressions 21.

FIG. 3 shows how the surface properties of the rows 22, 23 differ from one another in a first exemplary embodiment of the invention. In a first group of rows 22, the surface of the array 20 is unmodified and has a surface roughness of 1 μm. In a second group of rows 23, the surface of the array 20 was roughened. The roughened areas 24 each have a surface roughness of 20 μm.

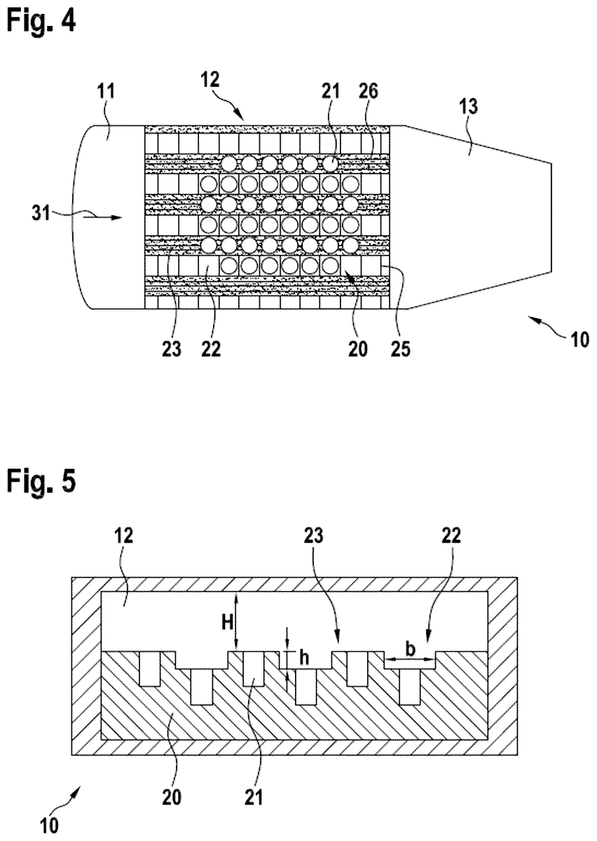

In a second exemplary embodiment of the invention shown in FIG. 4, the rows 22 of the first group each have grooves 25 that run orthogonally to the flow direction 31. The rows 23 of the second group each have grooves 26 that run parallel to the flow direction 31. All grooves 25, 26 in the present exemplary embodiment have a semi-circular cross-section and have a depth of 15 μm. Two grooves 25, 26 adjacent within a row 22, 23 are each 50 μm apart.

FIG. 5 shows an array chamber 12 of a microfluidic device 10 according to a third exemplary embodiment of the invention. A channel height H of 500 μm is free between the highest point of the top side of the array 20 and the top side of the array chamber 12. The surfaces of the rows 22 of the first group are each lowered by a value h of 75 μm relative to the rows 23 of the second group. As a result, the rows 22 of the first group are configured as channels that run along the flow direction 31 over the entire length of the array 20.

The width b of the rows 22, 23 is, for example, 450 μm in all exemplary embodiments.

A plurality of surface modifications according to the first to third exemplary embodiment of the invention may be combined with one another in a microfluidic device 10 according to the present invention.

1. An array for a microfluidic device, comprising:
a base body having a side that defines parallel surface rows,
wherein adjacent surface rows of the parallel surface rows include a first surface row and a second surface row each having at least one different surface property in relation to the other,
wherein the base body further defines depressions that extend into the base body, and
wherein the depressions are arranged in the parallel surface rows.

2. The array according to claim 1, wherein:
the adjacent surface rows alternately belong to a first group of surface rows and to a second group of surface rows, and
the first group of surface rows has at least one first surface property, and the second group of surface rows has at least one second surface property, and
the at least one first surface property and the at least one second surface property are different from each other.

3. The array according to claim 2, wherein:
the at least one first surface property is a first surface profiling,
the at least one second surface property is a second surface profiling, and
the first surface profiling is different from the second surface profiling.

4. The array according to claim 3, wherein:
the first surface profiling includes first grooves that possess a first depth and/or a first spacing distance and/or a first orientation,
the second surface profiling includes second grooves that possess a second depth and/or a second spacing distance and/or a second orientation, and
the first depth and/or the first spacing distance and/or the first orientation are respectively different from the second depth and/or the second spacing distance and/or the second orientation.

5. The array according to claim 2, wherein:
the at least one first surface property is a first a surface height,
the at least one second surface property is a second surface height, and
the first surface height is different from the second surface height.

6. The array according to claim 5, wherein the first surface height differs from the second surface height by a value that is in the range of 50 μm to 100 μm.

7. The array according to claim 2, wherein:
the at least one first surface property is a first a surface roughness,
the at least one second surface property is a second surface roughness, and
the first surface roughness is different from the second surface roughness.

8. The array according to claim 7, wherein the first surface roughness differs from the second surface height by a factor in the range of 5 to 50.

9. A microfluidic device, comprising:
at least one array chamber; and
an array according to claim 2,
wherein the array is arranged in the at least one array chamber such that the parallel surface rows run parallel to a flow direction of a fluid designed to flow through the at least one array chamber.

10. The microfluidic device according to claim 9, wherein:
the at least one first surface property is a first a surface height,
the at least one second surface property is a second surface height,
the first surface height is different from the second surface height,
wherein the first surface height differs from the second surface height by a value that is in the range of 50 μm to 100 μm, and
wherein the first surface height further differs from the second surface height by a value that ranges from 10% to 20% of a channel height of the array chamber.

11. A method for operating the microfluidic device according to claim 9, comprising:
guiding the fluid through the at least one array chamber such that the fluid flows along the parallel surface rows and over the side of the base body of the array.
